(19) United States
(12) Patent Application Publication
(10) Pub. No.: US 2012/0079919 A1
(43) Pub. Date: Apr. 5, 2012

(54) OIL FILTER CANISTER ADAPTER

(76) Inventors: Lung-Shan Chen, Taichung City (TW); Lien-Chin Chen, Taichung City (TW); Ching-Fang Chen, Taichung City (TW)

(21) Appl. No.: 13/209,347

(22) Filed: Aug. 12, 2011

(30) Foreign Application Priority Data
Oct. 1, 2010 (TW) 099218982

(51) Int. Cl. B25B 13/28; B25B 13/48

(52) U.S. Cl. 81/90.2

(57) ABSTRACT

An oil filter canister adapter of the present invention mainly includes a base, a rotatable plate, three rotatable members, and three holders. The rotatable plate and the rotatable members are respectively disposed on the base. The rotatable members contact with the rotatable plate respectively, so that the rotatable plate can rotate and drive the rotatable members to rotate. The holders are detachably disposed on the rotatable members respectively. Distances between any two adjacent holders are consistent in value. The distances between the holders are adjustable when the rotatable members rotate.

Therefore, the holders can be detached from the rotatable members. Volume of the adapter is minimized for storage. As such, cost of transportation or storage of the adapter can be well controlled.

### BACKGROUND OF THE INVENTION

1. Field of the Invention

The present invention relates to an apparatus for installing or uninstalling an oil filter canister.

2. Description of the Prior Art

Engine oil is used as lubricant for lubricating parts of engine or automobile. After using, metal particle or detritus would be carried in oil. Thus, oil filter is necessary for removing the particle or detritus from oil. When the particle or detritus accumulates, the oil filter would be obstructed. Thus, the oil filter should be exchanged regularly. Generally, oil filter is made as a canister. Since several sizes of canister are made by providers and used by user, servicemen should prepare several sizes of tools to fit with the canisters.

To fit with the canisters, a canister adapter is provided in TW utility model TWM401512 by applicant. Parts of the canister adapter can be rotated so as to adjusting the canister adapter to fit with a canister. Thus, single tool can be used for installing or uninstalling canister which has an unexpected size.

Though the canister adapter mentioned above achieves a great successful, the clutches or holders of the canister adapter still take a considerable volume. Thus, the canister adapter is unsuitable for transportation or storage.

The present invention is, therefore, arisen to obviate or at least mitigate the above mentioned disadvantages.

### SUMMARY OF THE INVENTION

The main object of the present invention is to provide an oil filter canister adapter which can be transported or stored easily.

To achieve the above and other objects, an oil filter canister adapter of the present invention includes a base, at least a rotatable plate, at least three rotatable members, and at least three holders.

The rotatable plate is rotatably disposed on the base. The rotatable members are rotatably disposed on the base respectively. The rotatable members are arranged around the rotatable plate. The rotatable members contact to the rotatable plate respectively. The rotatable members are driven to rotate by the rotatable plate when the rotatable plate rotates.

Each of the holders is rotatably and manual detachably disposed on one of the rotatable members. Each of the holders is able to rotate arbitrarily about an axis with respect to the corresponding rotatable member. The axes of the holders are non-coplanar. Distances between any two adjacent holders are consistent in value. Distances between any two adjacent holders are adjustable by rotating the rotatable members.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a first embodiment of the present invention;

FIG. 2 is another stereogram showing a first embodiment of the present invention;

FIG. 3 is a breakdown drawing showing a first embodiment of the present invention;

FIG. 4 is a drawing showing an operation condition of a first embodiment of the present invention;

FIG. 5 is another drawing showing an operation condition of a first embodiment of the present invention;

FIG. 6 is a drawing showing an adjustment condition of a first embodiment of the present invention;

FIG. 7 is another drawing showing an adjustment condition of a first embodiment of the present invention;

FIG. 8 is a stereogram showing a second embodiment of the present invention.

### DETAILED DESCRIPTION OF THE PREFERRED EMBODIMENTS

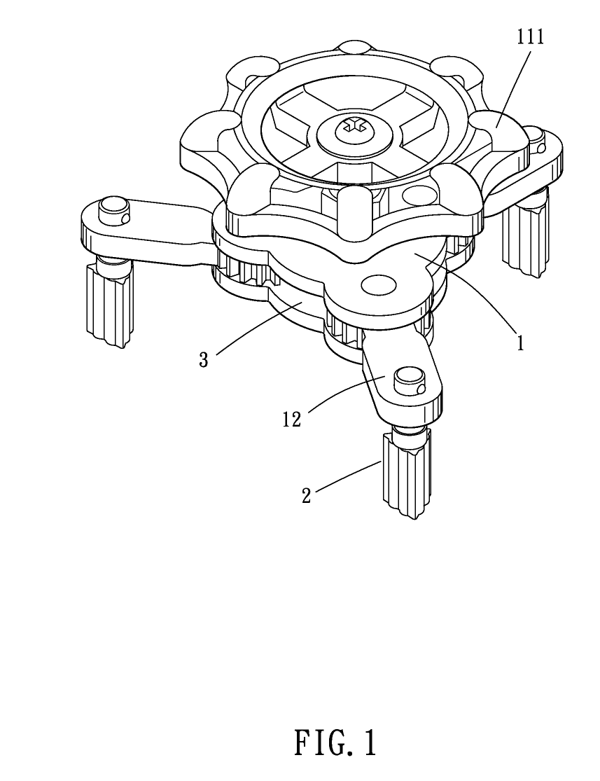

Please refer to FIG. 1 to FIG. 4 for a first embodiment of the present invention. The oil filter canister adapter, which is used for installing or uninstalling an oil filter canister 4, of the present embodiment includes a base 1, a rotatable plate 11, three rotatable members 12, and three holders 2.

The rotatable plate 11 and the rotatable members 12 are disposed on the base 1 respectively. Each of the rotatable plate 11 and the rotatable members 12 is able to rotate with respect to the base 1. The rotatable members 12 are arranged around the rotatable plate 11. Preferably, the rotatable members 12 are arranged equidistantly. In other words, distances between any two adjacent rotatable members 12 are consistent in value. The rotatable members 12 contact with the rotatable plate 11 respectively. Thus, the rotatable members 12 are driven to rotate by the rotatable plate 11 when the rotatable plate 11 rotates. To ensure the rotatable members 12 can be driven by the rotatable plate 11, the rotatable plate 11 and the rotatable members 12 are toothed. The rotatable plate 11 engages with each of the rotatable members 12.

Each of the holders 2 is rotatably and manual detachably disposed on one of the rotatable members 12. In other words, the holders 2 are able to rotate arbitrarily about an axis with respect to the corresponding rotatable member 12, and the holders 2 are able to be detached by hands. The axes of the holders 2 are non-coplanar, and the longitudinal directions of the holders 2 are non-coplanar, also. The holders 2 are arranged equidistantly around the rotatable plate 11. That is to say, distances between any two adjacent holders 2 being consistent in value. When the rotatable members 12 rotate, the holders 2 would move simultaneously. Distances between any two adjacent holders 2 are adjusted by rotating the rotatable members 12. It is noted that interval distance of any two adjacent holders 2 is equal to another one when the holders 2 are driven to move or rotate.

The oil filter canister adapter may further include a base plate 3. The base plate 3 is detachably disposed on the base 1. The rotatable plate 11 and the rotatable members 12 are located between the base 1 and the base plate 3.

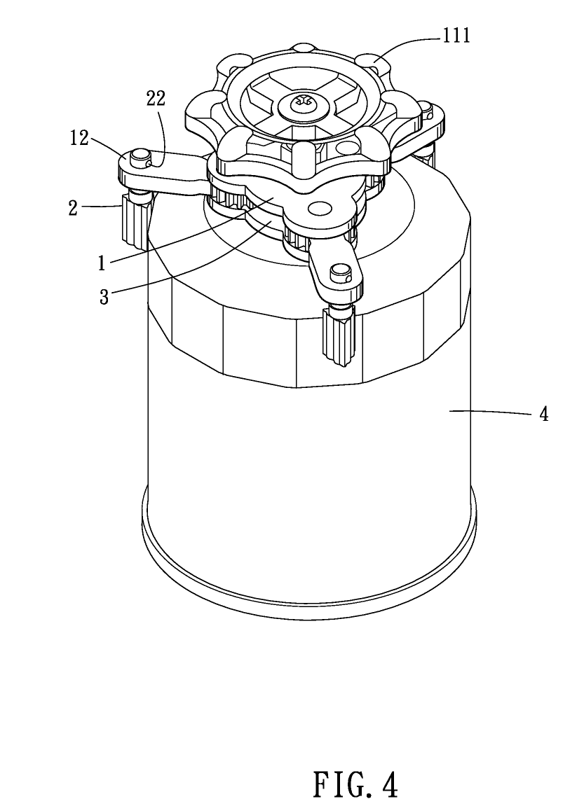

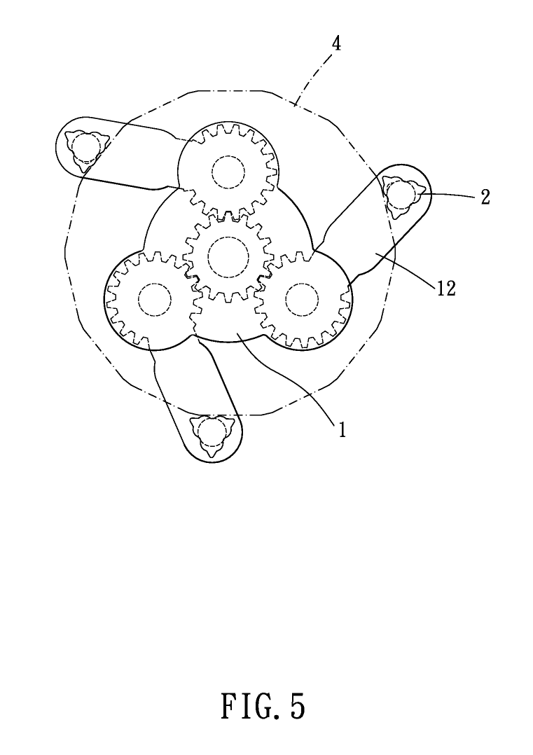

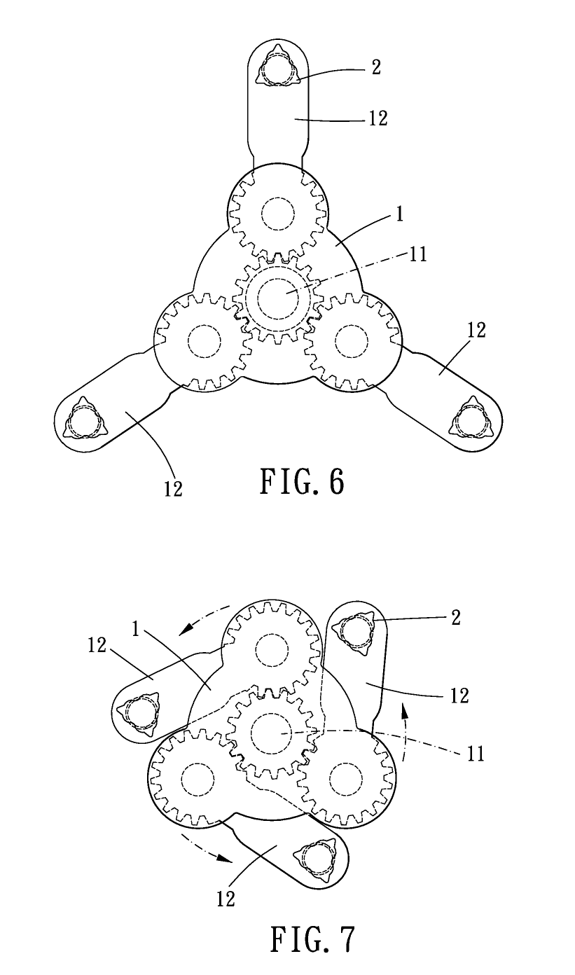

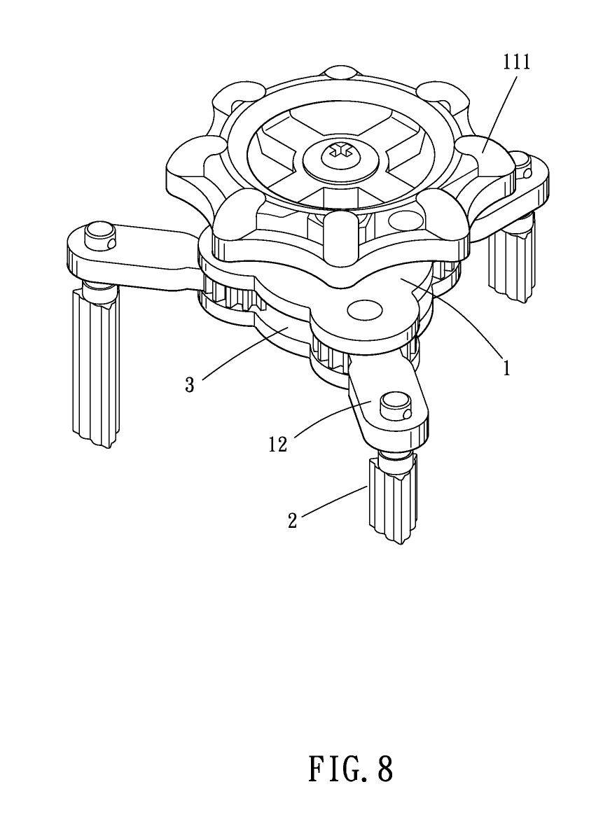

When the oil filter canister adapter is used for installing or uninstalling the oil filter canister 4, the oil filter canister adapter is aimed toward the oil filter canister 4. The oil filter canister 4 is then positioned between the holders 2. User can rotate the rotatable plate 11, clockwise or counterclockwise, so as to drive the rotatable members 12 to rotate. Distances between holders 2 are then enlarged, as shown in FIG. 6, or dwindled, as shown in FIG. 7, to fit with the oil filter canister 4. As such, the holders 2 can clutch the oil filter canister 4 effectively, as shown in FIG. 4 and FIG. 5, even the oil filter canister has a special size. Installing and uninstalling of the oil filter canister 4 can be progressed smoothly since user can rotate the oil filter canister 4 by rotating the oil filter canister adapter.

For operational purpose, a rotation handle 111 may be disposed on the rotatable plate 11. The rotation handle 111 may be formed with a wave shaped contour or a polygonal contour so as to be grabbed easily by hand. Thus, the rotatable plate 11 can be driven to rotate by the rotation handle 111. For engaging with the rotation handle 111 or another socket assembly, a connector 112 may be disposed on a center of the rotatable plate 11. The connector 112 has an appearance corresponding to the rotation handle 111 of another socket assembly. The connector 112 can be engaged with the rotation handle 111 or the socket assembly, so that the rotatable plate 11 can be driven to rotate by the rotation handle 111 or the socket assembly. More particularly, the connector 112 is formed with a non-circular groove so as to engage with the rotation handle 111 or the socket assembly. In other possible embodiment of the present invention, the connector 112 may be formed with a protrusion for engagement purpose.

When the oil filter canister adapter is used for installing or uninstalling the oil filter canister 4, the oil filter canister 4 would abut against the base plate 3. A magnetic member 13 may be disposed in the oil filter canister adapter. Preferably, the magnetic member 13 is disposed on the rotatable plate 11. Thus, when the oil filter canister adapter is aimed toward and closes to the oil filter canister 4, the magnetic force provided by the magnetic member 13 would pull the oil filter canister 4 and the oil filter canister adapter together. The oil filter canister adapter can clutch or engage with the oil filter canister 4 easily.

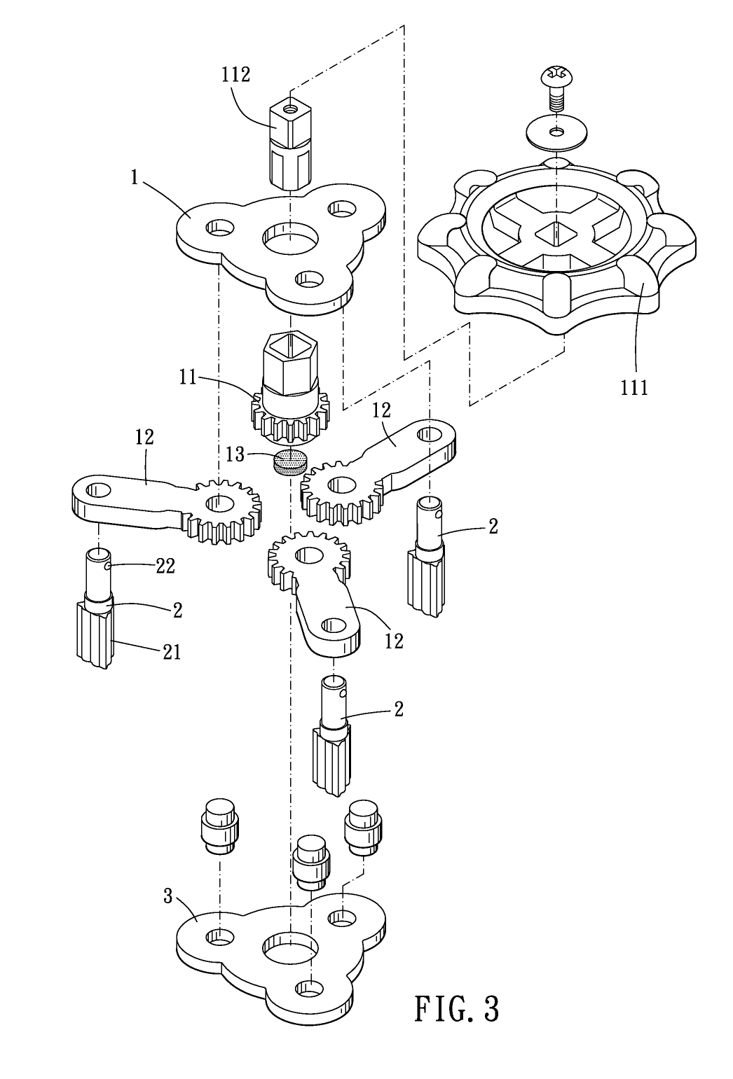

To engage with the oil filter canister efficiently, the holders 2 are taken as prisms. Preferably, each of the holders 2 is a trihedral prism. Further, each of the holders 2 is formed with plural elongated grooves, as shown in FIG. 3. Thus, the holders 2 can be firmly engaged with the oil filter canister 4.

Furthermore, each of the holders 2 may be covered by a plastic layer. As such, abrasion and distortion on the oil filter canister 4 caused by the holders 2 are minimized. Appearance and structure of the oil filter canister 4 can be maintained well.

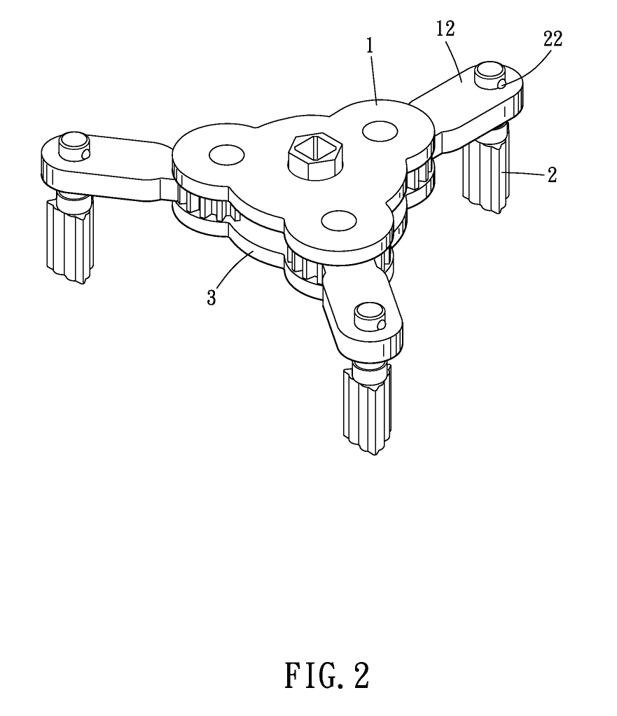

It is noted that the holders 2 is detachably disposed on the rotatable members 12 in the present invention. That is to say, the holders 2 can be removed from the rotatable members 12 by user. For manual operation purpose, each of the holders 2 is disposed with a ball 22 and an elastic member, as shown in FIG. 2. Each of the balls 22 is able to move between a protruding position and a recessing position. The elastic members make the balls 22 having a tendency to move toward the protruding position. More particularly, the elastic members provide elastic force to push the balls 22 to protrude outwardly. When the balls 22 locate at their protruding position, the holders 2 are engaged with the rotatable members 12. The holders 2 can not fall from the rotatable members 12 arbitrarily. When the balls 2 locate at their recessing position, the holders 2 can be detached from the rotatable members 12. Thus, user can pull the holders 2 with a force surpassing the elastic force provided by the elastic member, and the holders 2 can be detached manually easily then.

Accordingly, the holders 2 can be detached from the rotatable members 12. When the surrounding working space is narrowed or crowded by other instrument, the holders can be detached and replaced with a shorter one or a flat one. Thus, oil filter canister detachment can be progressed smoothly.

Secondly, the holders can also be replaced with a longer one. Though the oil filter canister is lengthened, or even some workpieces is attached to the top portion of the oil filter canister, the holders can still clutch the oil filter canister without distorting the oil filter canister.

If the oil filter canister is distorted already, it is difficult to detach the oil filter canister with holders which have a consistent length. With the present invention, the holders can be partially exchanged with one which has a proper length. Thus, the distorted oil filter canister can still be detached easily.

Fourthly, conventional adapter can not be detached in several parts. Volume of the adapter or the packing box is considerable large. The oil filter canister adapter of the present embodiment is provided with detachable holders. Thus, the holders can be detached when storing or transporting. Volume of the packing box can be reduced. Cost of the storing and transporting can be well controlled. Further, transportation damage can be diminished with suitable packing boxes.

If some of the holders are destroyed, the corresponding holders can be exchanged individually since each of the holders is detachable. Thus, even if some of the holders are damaged, there is no need to discard the whole oil filter adapter.

Finally, the holders can be detached after using. Thus, the rotatable members, the base plate, and the rotatable plate can be cleaned easily. Detritus and smudge in seam can still be removed.

To conclude, the oil filter canister adapter can fit with several sizes of oil filter canisters, and can also be operated in several using conditions. Furthermore, cost of storing and transporting can be controlled lower. Product competitive power and marketing are highly strengthened.

What is claimed is:

1. An oil filter canister adapter, comprising:
a base;
at least a rotatable plate, being rotatably disposed on the base;
at least three rotatable members, being rotatably disposed on the base respectively, the rotatable members being arranged around the rotatable plate, the rotatable members contacting to the rotatable plate respectively, the rotatable members being driven to rotate by the rotatable plate when the rotatable plate rotates; and
at least three holders, each of the holders being rotatably and manual detachably disposed on one of the rotatable members, each of the holders being able to rotate arbitrarily about an axis with respect to the corresponding rotatable member, the axes of the holders being non-coplanar, distances between any two adjacent holders being consistent in value, distances between any two adjacent holders being adjustable by rotating the rotatable members.

2. The oil filter canister adapter of claim 1, further comprising a base plate, the base plate being detachably disposed on the base, the rotatable plate and the rotatable members being located between the base and the base plate.

3. The oil filter canister adapter of claim 1, wherein a rotation handle is disposed on the rotatable plate, the rotatable plate is driven to rotate by the rotation handle.

4. The oil filter canister adapter of claim 1, wherein a connector is disposed on a center of the rotatable plate, the connector has an appearance corresponding to a socket assembly, the connector is adapted for the socket assembly to engage therewith, so that the rotatable plate is driven to rotate by the socket assembly.

5. The oil filter canister adapter of claim 1, wherein a magnetic member is disposed on the rotatable plate.

6. The oil filter canister adapter of claim 1, wherein each of the holders is a prism.

7. The oil filter canister adapter of claim 1, wherein each of the holders is formed with plural elongated grooves.

8. The oil filter canister adapter of claim 1, wherein each of the holders is covered by a plastic layer.

9. The oil filter canister adapter of claim 1, wherein each of the holders is disposed with a ball and an elastic member, each of the balls is able to move between a protruding position and a recessing position, each of the elastic members makes the corresponding ball having a tendency to move toward the protruding position, each of the holders is engaged with the corresponding rotatable member when the corresponding ball is located at the corresponding protruding position, each of the holders is able to be detached from the corresponding rotatable member when the corresponding ball is located at the corresponding recessing position.
